(19) United States
(12) Patent Application Publication
(10) Pub. No.: US 2005/0034772 A1
(43) Pub. Date: Feb. 17, 2005

(54) Relay valve

(76) Inventor: Robert J. Herbst, Avon, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/640,594

(22) Filed: Aug. 13, 2003

(51) Int. Cl. F15B 13/042

(52) U.S. Cl. 137/627.5

(57) ABSTRACT

A valve (10) for controlling fluid flow to and from an actuatable device (30) includes a housing (34) defining a chamber (90) for establishing fluid communication between a fluid supply (14) and the actuatable device (30). A spherical ball (120) controls fluid flow through the chamber (90). The housing (34) has a housing seat (84) on which the ball (120) can be seated. A piston (100) movable in the chamber (90) in response to a control input has a piston seat (106) on which the valve element (120) can be seated. The valve (10) has an exhaust condition in which the ball (120) is seated on the housing seat (84) and is spaced apart from the piston seat (106), and a supply condition in which the ball is seated on the piston seat and is spaced apart from the housing seat, and a hold condition in which the ball (120) is seated on the housing seat (84) and the piston seat (106) is seated against the ball (120) simultaneously.

### BACKGROUND OF THE INVENTION

The present invention relates to a relay valve and, in particular, to a valve for controlling fluid flow between components of a fluid system, such as an air braking system of a vehicle.

A typical air braking system of a vehicle, such as a tractor-trailer, includes a source of air under pressure such as a compressor and a reservoir. The pressurized air is selectively directable to one or more actuatable devices of the vehicle, such as brake actuators. When the vehicle operator depresses the brake pedal, pressurized air is directed from the air supply through a relay valve to the brake actuators of the vehicle to effect braking action. When the vehicle operator thereafter releases the brake pedal, the pressurized air flows out of the brake actuators through the relay valve to exhaust. The brake pedal thus serves as a control to control direction of fluid flow through the relay valve. Braking control can be modulated with the valve by applying more or less pressure to the brake pedal.

### SUMMARY OF THE INVENTION

The present invention relates to a valve for controlling fluid flow to and from an actuatable device. In one embodiment the valve includes a housing defining a chamber for establishing fluid communication between a fluid supply and the actuatable device. The valve also includes a spherical ball for controlling fluid flow through the chamber. The housing has an inlet seat on which the ball can be seated. A piston is movable in the chamber in response to a control input. The piston has an exhaust seat on which the ball can be seated. The valve has a first condition in which the ball is seated on the inlet seat and is spaced apart from the exhaust seat to block fluid flow from the fluid supply to the actuatable device and to enable venting of fluid from the actuatable device. The valve has a second condition in which the ball is seated on the exhaust seat to block venting of fluid from the actuatable device and is seated on the inlet seat to block fluid flow from the fluid supply to the actuatable device. The valve has a third condition in which the ball is seated on the exhaust seat and is spaced apart from the inlet seat to enable fluid flow from the fluid supply to the actuatable device and to block venting of fluid from the actuatable device.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic illustration of components of an air brake system including a relay valve in accordance with the present invention;

FIG. 2 is a sectional view of the valve of FIG. 1, shown in a first or exhaust condition;

FIG. 3 is a view similar to FIG. 2 showing the valve in a second or balanced or intermediate condition;

FIG. 4 is a view similar to FIG. 2 showing the valve in a third or supply condition;

FIG. 5 is an enlarged view of a portion of the valve shown in the third condition; and

FIG. 6 is an enlarged view similar to FIG. 5 showing a portion of the valve with a ball valve element removed.

### DETAILED DESCRIPTION OF THE INVENTION

The present invention relates to a valve and, in particular, to a relay valve for controlling fluid flow between components of a fluid system, such as an air braking system of a vehicle. The present invention is applicable to valves of various different constructions and is applicable to valves for controlling fluid flow in systems of various different constructions, for example, air systems or hydraulic systems. As representative of the present invention, FIG. 1 illustrates schematically a relay valve 10 that forms part of a fluid system 12.

The fluid system 12 includes, in addition to the valve 10, a fluid supply indicated at 14. The fluid supply 14 in the illustrated embodiment is a source of air under pressure such as a compressor and/or a reservoir. The fluid supply 14 is connected to the valve 10 via a supply line 16. In other systems, the fluid supply 14 could have a different makeup.

The fluid system 12 also includes a fluid exhaust indicated at 18. The fluid exhaust 18 in the illustrated embodiment is a location or device at which air can be vented from the valve 10 through a fluid exhaust line 20. In other systems, the fluid exhaust 18 could have a different makeup.

The fluid system 12 also includes a control indicated at 22. The control 22 is structure operative to provide a control signal to the relay valve. The control 22 in the illustrated embodiment is structure (the vehicle brake pedal) that provides a pilot pressure over a control line 24 to the valve 10. In different fluid systems, the control 22 could have a different makeup. For example, the control 22 could be a simple air valve that supplies air under pressure when a vehicle brake pedal is depressed. The control 22 could be or include a pneumatic solenoid. The control 22 could, alternatively, be a direct mechanical connection between a solenoid and the valve 10. Thus, a valve 10 of the present invention is usable in a simple (non-antilock) air brake system, or in an antilock braking system. Either system could include plural wheels controlled by plural valves 10, or plural wheels all controlled by one valve 10.

The fluid system 12 also includes a delivery 28 and an actuatable device 30. The actuatable device 30 in one embodiment is a brake actuator for a commercial vehicle, such as a tractor-trailer. The valve 10 is suitable for use in controlling fluid flow to other types of actuatable devices 30. The box 28 marked “delivery” in FIG. 1 is representative of the structure connected in fluid communication by a delivery line 32 between the valve 10 and the actuatable device 30. The delivery 28 may help to direct fluid flow between a plurality of actuatable devices 30 controlled by one relay valve 10.

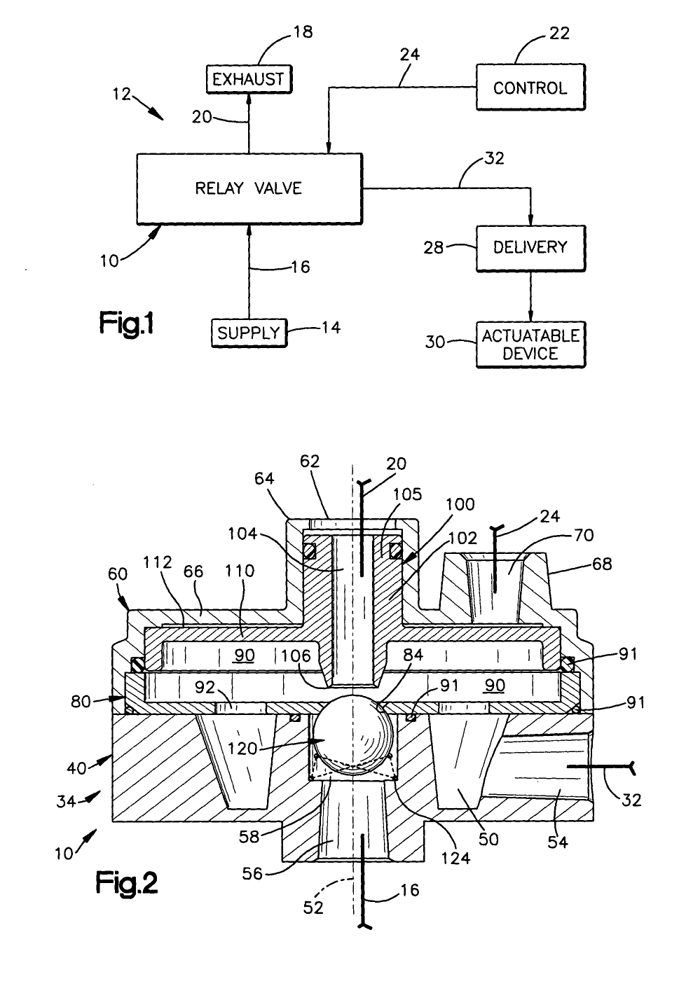

The valve 10 (FIG. 2) includes a housing 34. The housing 34 is shown in FIG. 2 as a plurality of pieces secured together in a fluid-tight manner. Specifically, the housing 34 shown in the embodiment of FIG. 2 includes a base 40, a cap 60, and an inlet adapter 80 that is captured between the base and the cap. The housing 34 could be constructed in another manner and could be, for example, a portion of a larger structure.

The parts of the housing 34 as illustrated are made from metal, such as stainless steel or aluminum. The housing 34 could alternatively be made from another material, such as a hard plastic.

The base 40 of the housing 34 includes an annular delivery passage 50 centered on a longitudinal central axis 52 of the valve 10. The delivery passage 50 connects with a radially extending delivery port 54 formed in the base 40. The delivery port 54 is connected in fluid communication with the actuatable device 30 by the delivery line 32.

The housing base 40 also includes an axially located supply port 56. The supply port 56 is connected in fluid communication with the fluid supply 14 by the supply line 16. The inward end of the supply port 56 terminates in a cylindrical supply passage 58 centered on the axis 52.

The housing cap 60 includes an exhaust port 62 that is centered on the axis 52. The exhaust port 62 is formed in a cylindrical portion 64 of the cap 60 that projects axially from a main wall 66 of the cap. The exhaust port 62 is connected in fluid communication with the fluid exhaust 18 by the exhaust line 20.

Another axially projecting portion 68 of the cap 60, spaced radially from the exhaust portion 64, defines a control port 70 of the valve 10. The control port 70 is connected in fluid communication with the fluid control 22 by the control line 24.

The four ports 54, 56, 62 and 70 of the valve 10 are shown in FIG. 2 as being openings in the housing 34. It should be understood that the ports 54, 56, 62 and 70 could be formed differently, for example, as connectors extending outward from the housing 34, or in another manner.

The inlet adapter 80 is illustrated as a plate-like member that is captured axially and radially in the housing 34 between the cap 60 and the base 40. The inlet adapter 80 could, alternatively, be formed in a different manner and could be formed as one piece with one or more other parts of the housing 34.

The inlet adapter 80 has a central opening 82 (FIG. 6) centered on the axis 52. The central opening 82 is bounded by a portion of the inlet adapter that forms a first valve seat or inlet seat 84. The inlet seat 84 is defined by a frustoconical surface 86 formed on the inlet adapter 80 and centered on the axis 52. The surface 86 faces the base 40.

The housing 34 defines a chamber 90 in the housing. The chamber 90 is sealed by a plurality of seals 91. The chamber 90 is bounded axially on one end by the main wall 66 of the cap 60 and on the other end by the inlet adapter 80.

The inlet adapter 80 has one or more axially extending openings 92 that provide fluid communication between the chamber 90 and the annular delivery passage 50. The inlet seat 84 in the inlet adapter 80 provides fluid communication between the chamber 90 and the supply passage 58.

The valve 10 includes a movable member or control member in the form of a piston 100. The piston 100 as illustrated has a cylindrical central body portion 102 centered on the axis 52. A cylindrical exhaust passage 104 extends axially through the central body portion 102 of the piston 100. The central body portion 102 is received in the projecting portion 64 of the housing cap 60. The piston 100 is thus supported for sliding movement relative to the housing 34 in a direction along and parallel to the axis 52. The exhaust passage 104 terminates at its outer end adjacent the exhaust port 62.

The inner end of the central portion 102 of the piston 100 is of reduced diameter and terminates in a second valve seat or exhaust seat 106. The exhaust seat 106 (FIG. 6) is defined by a frustoconical surface 108 formed on the central portion 102 of the piston 100 and centered on the axis 52. The surface 108 faces the base 40. The frustoconical surface 108 is slightly smaller in diameter than the frustoconical surface 86 that defines the inlet seat 84. As a result, the exhaust seat 106 of the valve 10 is slightly smaller in diameter than the inlet seat 84 of the valve.

The exhaust seat 106 is located in the chamber 90 in the valve 10. The exhaust seat 106 establishes fluid communication between the chamber 90 and the exhaust passage 104 in the piston 100. The exhaust seat 106, the inlet seat 84, the exhaust passage 104 and the supply passage 58 are all disposed in one straight line, centered on the axis 52, with the exhaust seat and the piston seat being located between the exhaust passage and the supply passage.

The piston 100 has an annular control portion 110 that extends radially outward from the central body portion 102 in a direction parallel to and inward of the main wall 66 of the cap 60. The control portion 110 of the piston 100 has an annular, axially facing outer surface 112 that is exposed to the fluid in the control port 70. As a result, changes in fluid pressure in the control port 70 can cause changes in the forces acting on the piston 100 in an axial direction.

The valve 10 includes a movable valve element in the form of a ball 120. The ball 120 has a spherical configuration with a spherical outer sealing surface 122. The ball 120 is preferably made from a material that is hard enough to prevent deformation of the sealing surface 122 of the ball during the lifetime of the valve 10. One suitable material is chrome steel. The ball 120 may alternatively be made from a hard plastic material.

The ball 120 is disposed substantially in the supply passage 58 in the base 40 of the housing 34. The ball 120 is smaller in diameter than the supply passage 58. As a result, fluid can flow around the ball 120 through the supply passage 58. In addition, the ball 120 is movable axially in the supply passage 120.

The ball 120 is larger in diameter than the inlet seat 84 on the inlet adapter 80 of the housing 34. As a result, the ball 12 can be seated on the inlet seat 84. When the ball 120 is seated on the inlet seat 84, the spherical sealing surface 122 of the ball makes line contact with the frustoconical surface 86 of the inlet seat. This line contact forms a seal that blocks fluid flow between the supply passage 58 and the chamber 90. An optional spring 124 helps to hold the ball 120 in position on the inlet seat 84.

The ball 120 is also larger in diameter than the exhaust seat 106 on the piston 100. As a result, the ball 120 can be seated on the exhaust seat 106. When the ball 120 is seated on the exhaust seat 106, the spherical sealing surface 122 of the ball makes line contact with the frustoconical surface 108 of the exhaust seat. This line contact forms a seal that blocks fluid flow between the exhaust passage 104 and the chamber 90.

The chamber 90 establishes fluid communication between several of the ports of the housing. Specifically, the chamber 90 provides a fluid flow path for fluid to flow between the supply port 56 and the delivery port 54. The chamber 90 also provides a fluid flow path to flow between the delivery port 54 and the exhaust port 62. Fluid flow through the chamber 90 is controlled by the piston 100 and the ball 120 in response to a control input through the control port 70, as described below.

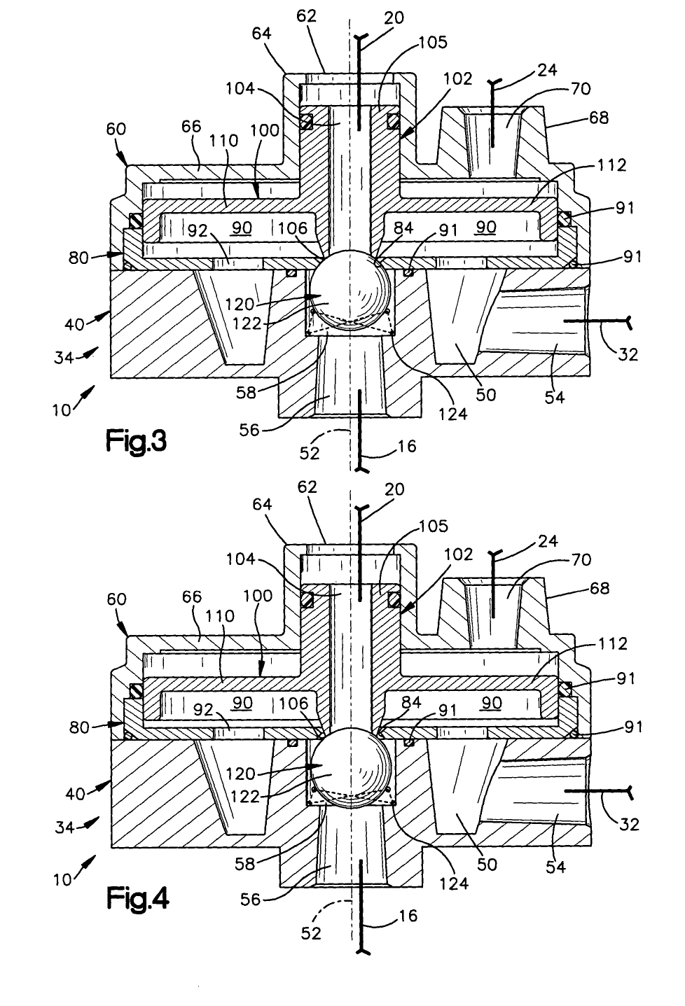

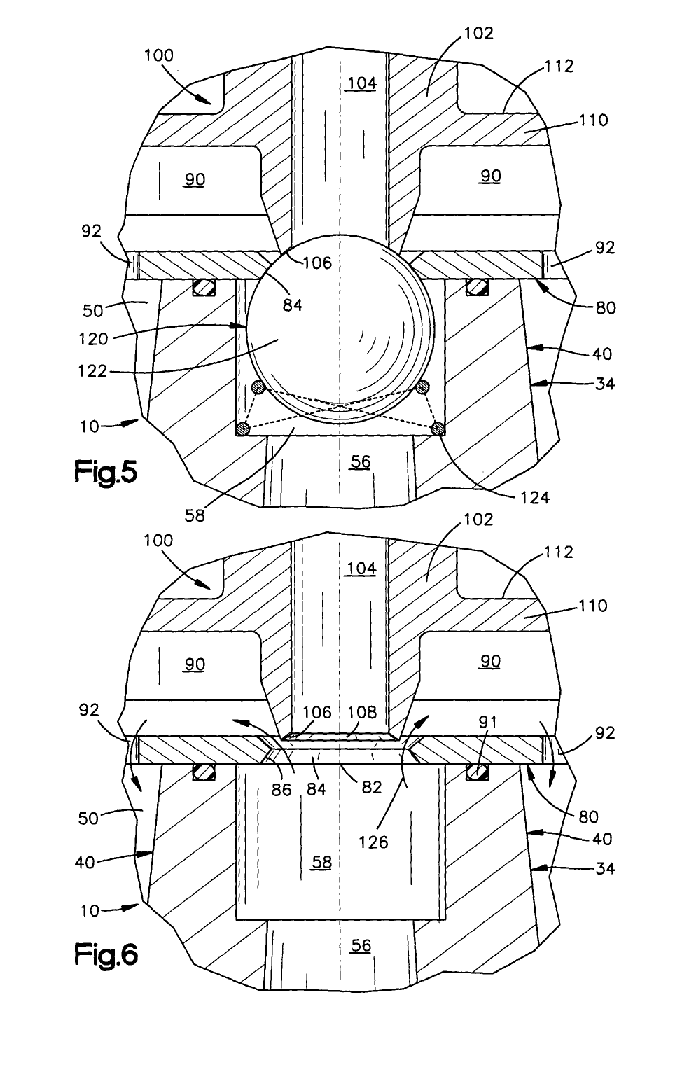

Depending on the control input, the valve 10 can be placed in one of three primary conditions in which the piston 100 and the ball 120 are in three different positions relative to the housing 34: a first or exhaust condition as shown in FIG. 2; a second, or balanced, or intermediate, condition as shown in FIG. 3; and a third or supply condition as shown in FIG. 4.

When the valve 10 is in the first condition, the parts of the valve are in the relative positions shown in FIG. 2. The valve 10 is in the first condition when the fluid pressure in the control port 70 is relatively low compared to the pressure of the fluid at the delivery port 54 and thus in the chamber 90. This can occur, for example, when the operator of the vehicle in which the valve 10 is incorporated, is not pressing on the brake pedal of the vehicle.

When the fluid pressure in the control port 70 is thus relatively low, the force of the fluid in the chamber 90, tending to move the piston 100 upward as viewed in FIG. 2, exceeds the force of the fluid from the control port 70 tending to move the piston 100 downward as viewed in FIG. 2. The piston 100 is therefore disposed adjacent the main wall 66 of the housing cap 60 as shown in FIG. 2.

At the same time, the pressure in the supply passage 58 is relatively high because of the pressure of the fluid coming from the supply 14 through the supply port 56. This relatively high fluid pressure acts constantly on the ball 120, urging the ball to move inward in the supply passage 58 of the valve 10, in a direction toward the inlet seat 84 and the exhaust seat 106. The ball 120 engages and seals against the inlet seat 84. The inlet seat 84 limits movement of the ball 120 in the inward direction.

When the pressure in the control port 70 is relatively low and the ball 120 is thus held against the inlet seat 84, the exhaust seat 106 on the piston 100 is spaced apart from the ball. Therefore, fluid communication is established between the chamber 90 and the exhaust passage 104. Specifically, fluid can flow from the chamber 90 through the exhaust seat 106 and into the exhaust passage 104.

Because of the presence of the openings 92 in the inlet adapter 80, the chamber 90 is constantly in fluid communication with the delivery passage 50 and the delivery port 54. Therefore, fluid can flow between the delivery passage 50 and the exhaust passage 104, when the valve 10 is in the first condition shown in FIG. 2.

The fluid pressure at the exhaust 18 is lower than the fluid pressure at the actuatable device 30. Therefore, when the valve 10 is in the first condition as shown in FIG. 2, fluid flows from the actuatable device 30, through the delivery line 32 and the delivery port 54, into the delivery passage 50 in the valve. This fluid flows from the delivery passage 50, through the openings 92 into the chamber 90, and out of the chamber through the exhaust seat 106 and the exhaust passage 104, to exhaust 18.

The first condition of the valve 10 is thus a condition in which the actuatable device 30 is exhausted or vented to exhaust 18. Relieving fluid pressure at a brake actuator in this manner serves to release the vehicle brake associated with the brake actuator.

When the fluid pressure in the control port 70 increases, the valve 10 moves in a transitory manner through the intermediate or balanced condition shown in FIG. 3 to the third or supply, condition shown in FIG. 4. This can occur, for example, when the operator of the vehicle in which the valve 10 is located, depresses the brake pedal of the vehicle.

When the fluid pressure in the control port 70 thus increases, the force of the fluid in the control port acting on the control portion 110 of the piston 100 increases to a level greater than the force of the fluid in the chamber 90 acting on the control portion of the piston. The piston 100 moves away from the main wall 66 of the housing cap 60 to the intermediate position shown in FIG. 3. The exhaust seat 106 on the piston 100 moves into engagement with the ball 120. The engagement of the ball 120 with the exhaust seat 106 blocks fluid flow from the chamber 90 into the exhaust passage 104.

When the piston 100 engages the ball 120, the fluid pressure in the supply passage 58, which is a constant, is relatively high, so the ball 120 is in engagement with the inlet seat 84. Therefore, when the valve 10 is in the intermediate condition, fluid can not flow into the chamber 90 from the supply 14, nor can it flow out of the chamber 90 through the exhaust passage 104. The intermediate condition of the valve 10 is thus a condition in which the actuatable device 30 is neither being further pressurized nor exhausted (vented to exhaust).

The intermediate condition of the valve 10, shown in FIG. 3, is a temporary or transitory condition when the vehicle brake pedal is first depressed. That is, the valve 10 moves immediately from the intermediate condition shown in FIG. 3 to the third or supply condition shown in FIG. 4 as the operator of the vehicle continues to maintain the brake pedal depressed. This occurs because the fluid pressure in the control port 70 is greater than the pressure from the delivery port 54 acting on the underside of the piston wall 110 when the vehicle brake pedal is first depressed.

Because of the imbalance of pressures on the piston 100, the piston moves farther away from the main wall 66 of the housing cap 60, to the position shown in FIG. 4. The exhaust seat 106 on the piston 100 remains in engagement with the ball 120. The engagement of the ball 120 with the exhaust seat 106 continues to block fluid flow from the chamber 90 into the exhaust passage 104.

The piston 100, as it moves to the third position, moves or pushes the ball 120 off the inlet seat 84, against the biasing effect of the fluid pressure in the supply passage 58 and of the spring 124. The ball 120 no longer seals against the inlet seat 84.

The movement of the ball 120 off the inlet seat 84 establishes fluid communication between the supply passage 58 and the chamber 90. Therefore, fluid can flow from the fluid supply 14, through the supply port 56 and the supply passage 58, around the ball 120 and into the chamber 90. Such fluid flow is indicated schematically by the arrows 126 in FIG. 6 (the ball 120 is, for clarity, not shown in FIG. 6).

The pressurized fluid entering the chamber 90 from the supply port 56 can not flow out of the valve 10 through the exhaust port 62, because the ball 120 (FIG. 4) is seated on the exhaust seat 106 of the piston 100. As a result, the fluid entering the chamber 90 from the supply port 56 flows through the openings 92 in the inlet adapter 80, into the delivery passage 50 in the base 40 of the housing 34. The fluid thence flows through the delivery port 54 to the actuatable device 30. The actuatable device 30 is actuated.

The third condition of the valve 10 is thus a condition in which the actuatable device 30 is being further pressurized. Providing increase fluid pressure to a brake actuator in this manner serves to increase the braking force that is provided by the vehicle brake that is associated with the brake actuator.

If the valve 10 is in the third condition shown in FIG. 4 and the operator maintains the same application of force on the brake pedal, the delivery pressure in cavity 90 increases to a level at which it balances the control pressure applied to port 70. The forces on the piston 100 are balanced, and the valve 10 moves back to the second condition shown in FIG. 3, with both the inlet seat 84 and the exhaust seat 106 seated against the sealing surface 122 on the ball 120. Inlet and exhaust are seated against the ball 120 and the intermediate delivered pressure is maintained.

If the operator depresses the brake pedal further, the piston 100 moves farther away from the main wall 66 of the cap 60 of the housing 34. The piston 100 moves the ball 120 off the inlet seat 84, momentarily allowing increased fluid pressure from the supply 14 to the actuatable device 30. This can increase the braking force provided by a brake actuator. After a very short period of time, the force on the piston 100 from the fluid in the chamber 90 balances with the force on the piston from the fluid in the control port 70, and the valve 10 again assumes its intermediate condition shown in FIG. 3.

Likewise, if the operator releases the brake pedal partially but not fully, the piston 100 moves closer to the main wall 66 of the cap 60 of the housing 34. The ball 120 moves against the inlet seat 84, closing the path for fluid flow from the supply 14 to the actuatable device 30. The exhaust seat 106 momentarily opens to reduce the pressure in the actuatable device and cavity 90 to balance the control pressure acting on top of the piston 100 at port 70. This can decrease the braking force provided by a brake actuator. The movement of the piston 100 ceases when the fluid pressure forces on the piston are balanced again and the ball 120 engages both the inlet seat 84 and the exhaust seat 106.

When the operator releases the brake pedal completely, the piston 100 moves back to its first position shown in FIG. 2. The ball 120, under the influence of the fluid pressure in the supply passage 58 and of the spring 124, moves back into engagement with the inlet seat 84. Fluid flow from the supply 14 to the actuatable device 30 is blocked, and the brake is thus released.

When the ball 120 is seated on the inlet seat 84, the line contact between the hard material of the ball and the hard material of the inlet seat provides a high unit loading seal between the fluid supply 14 and the chamber 90. Likewise, the line contact between the ball 120 and the exhaust seat 106, when the ball is seated on the exhaust seat, provides a high unit loading seal between the fluid exhaust 18 and the chamber 90. As a result, the valve 10 need not employ any rubber seals like those found in some prior art valves. This can help to minimize leakage at cold temperatures that can result from viscosity changes in rubber seals. Also, there is no compression set and attendant loss of unit loading. In addition, there is no need to bond two materials (rubber and metal or rubber and plastic) with the attendant cost and complexity.

The ball 120 is self-centering on the inlet seat 84 and on the exhaust seat 106 because of the spherical configuration of the ball and the frustoconical configuration of seats. As a result, no springs or mechanical guides are needed for the ball 120, which is the movable valve element in the valve 10 (the spring 124 is optional). Also, the ball 120 does not use any seals or O-rings as would a cylindrical element moving in a cylinder.

From the above description of the invention, those skilled in the art will perceive improvements, changes, and modifications in the invention. Such improvements, changes, and modifications within the skill of the art are intended to be included within the scope of the appended claims.

1. A valve for controlling fluid flow to and from an actuatable device, said valve comprising:
a housing defining a chamber for establishing fluid communication between a fluid supply and the actuatable device;
a spherical ball for controlling fluid flow through said chamber;
said housing having an inlet seat on which said ball can be seated; and
a piston movable in said chamber in response to a control input, said piston having an exhaust seat on which said ball can be seated;
said valve having a first condition in which said ball is seated on said inlet seat and is spaced apart from said exhaust seat to block fluid flow from the fluid supply to the actuatable device and to enable venting of fluid from the actuatable device;
said valve having a second condition in which said ball is seated on said exhaust seat to block venting of fluid from the actuatable device and is seated on said inlet seat to block fluid flow from the fluid supply to the actuatable device;
said valve having a third condition in which said ball is seated on said exhaust seat and is spaced apart from said inlet seat to enable fluid flow from the fluid supply to the actuatable device and to block venting of fluid from the actuatable device.

2. A valve as set forth in claim 1 wherein each one of said exhaust seat and said inlet seat has a circular configuration, said exhaust seat being smaller in diameter than said inlet seat.

3. A valve as set forth in claim 2 wherein said exhaust seat communicates with an exhaust port for venting fluid from said actuatable device through said chamber in said valve, and said inlet seat communicates with a supply port for receiving fluid from the fluid supply, said spherical ball being located between said inlet seat and said supply port.

4. A valve as set forth in claim 3 having an axis, said exhaust port and said supply port being located on said axis, said inlet seat and said exhaust seat both being located on said axis between said supply port and said exhaust port.

5. A valve as set forth in claim 4 wherein said ball when seated on said inlet seat has line contact with said inlet seat, and said ball when seated on said exhaust seat has line contact with said exhaust seat.

6. A valve as set forth in claim 1 having an axis, said valve having a supply port located on said axis and an exhaust port located on said axis, said inlet seat and said exhaust seat both being located on said axis between said supply port and said exhaust port.

7. A valve as set forth in claim 1 wherein said inlet seat and said exhaust seat are defined by respective frustoconical surfaces.

8. A valve as set forth in claim 1 wherein said ball when seated on said inlet seat has line contact with said inlet seat, and said ball when seated on said exhaust seat has line contact with said exhaust seat.

9. A valve as set forth in claim 1 wherein said piston has a vent passage in fluid communication with said exhaust seat for venting fluid from said actuatable device through said chamber.

10. A valve as set forth in claim 9 wherein said piston is reciprocable along an axis of said valve and said vent passage extends along said axis.

11. A valve for controlling fluid flow between a fluid supply, a fluid exhaust, and an actuatable device, said valve comprising:
a housing defining a chamber for establishing fluid communication between the fluid supply and the fluid exhaust and the actuatable device;
a supply port connected in fluid communication between the fluid supply and said chamber, an exhaust port connected in fluid communication between the fluid exhaust and said chamber, and a delivery port connected in fluid communication between the actuatable device and said chamber;
a spherical ball in said housing for controlling fluid movement through said chamber;
said housing having a first seat fixed in position relative to said chamber and on which said ball can be seated; and
a member movable in said chamber in response to a control input, said member having a second seat movable relative to said chamber and on which said valve element can be seated;
said valve having a first condition in which said movable member is in a first position relative to said housing and said ball is seated on said first seat and is spaced apart from said second seat, said valve when in the first condition establishing fluid communication between said delivery port and said exhaust port thereby to enable venting of fluid from said actuatable device, said valve when in the first condition blocking fluid communication between said delivery port and said supply port;
said valve having a second condition in which said valve element is seated on said second seat and is seated on said first seat to block venting of fluid from the actuatable device and to block fluid flow from the fluid supply to the actuatable device;
said valve having a third condition in which said ball is seated on said second seat and is spaced apart from said first seat to establish fluid communication between the fluid supply and the actuatable device and to block fluid communication between the actuatable device and the fluid exhaust thereby to block venting of fluid from the actuatable device.

12. A valve as set forth in claim 11 further including a control port in fluid communication with said movable member, said control port for receiving a control pressure, said movable member moving in said chamber in response to changes in said control pressure.

13. A valve as set forth in claim 11 wherein said first seat and said second seat have circular configurations defined by respective frustoconical surfaces, said second seat being smaller in diameter than said first seat.

14. A valve as set forth in claim 13 wherein said ball when seated on said first seat has line contact with said first seat, and said ball when seated on said second seat has line contact with said second seat.

15. A valve as set forth in claim 14 wherein said second seat communicates with an exhaust port for venting fluid from said actuatable device through said chamber in said valve, and said first seat communicates with a supply port for receiving fluid from the fluid supply, said spherical ball being located between said first seat and said supply port on an axis of said valve.

16. A valve for controlling fluid flow to and from an actuatable device, said valve comprising:
a housing defining a chamber for establishing fluid communication between a fluid supply and the actuatable device;
a movable valve member for controlling fluid flow through said chamber, said movable valve member having a non-planar seating surface;
said housing having a non-planar, inlet seat on which said valve member can be seated; and
a piston movable in said chamber in response to a control input, said piston having a non-planar, exhaust seat on which said valve member can be seated;
said valve having a first condition in which said valve member is seated on said inlet seat and is spaced apart from said exhaust seat to block fluid flow from the fluid supply to the actuatable device and to enable venting of fluid from the actuatable device;
said valve having a second condition in which said valve member is seated on said exhaust seat to block venting of fluid from the actuatable device and is seated on said inlet seat to block fluid flow from the fluid supply to the actuatable device;
said valve having a third condition in which said valve member is seated on said exhaust seat and is spaced apart from said inlet seat to enable fluid flow from the fluid supply to the actuatable device and to block venting of fluid from the actuatable device.

17. A valve as set forth in claim 16 wherein said movable valve member is a ball.

18. A valve as set forth in claim 16 wherein said movable valve member has a spherical seating surface and wherein each one of said exhaust seat and said inlet seat has a circular configuration.

19. A valve as set forth in claim 18 wherein said inlet seat and said exhaust seat are defined by respective frustoconical surfaces.

20. A valve as set forth in claim 19 wherein said movable valve member is a ball.

21. A valve as set forth in claim 16 wherein said seating surface and said seat are metal.
